(19) United States
(12) Patent Application Publication
(10) Pub. No.: US 2021/0185909 A1
(43) Pub. Date: Jun. 24, 2021

(54) Trimmer Head with Residual Trimmer Line Indicator

(71) Applicant: Andreas Stihl AG & Co. KG, Waiblingen (DE)

(72) Inventor: Florian Hoche, Besigheim (DE)

(21) Appl. No.: 17/120,172

(22) Filed: Dec. 13, 2020

(30) Foreign Application Priority Data
Dec. 19, 2019 (EP) 19 218 095.8

(51) Int. Cl. A01D 34/416

(52) U.S. Cl. CPC A01D 34/4163

(57) ABSTRACT

A trimmer head for mounting on a drive shaft of a trimmer has a housing and a trimmer line spool for winding and unwinding a trimmer line. The trimmer line spool is rotatably supported in the housing about an axis of rotation. The trimmer line spool has a first rotational direction in relation to the housing and a second rotational direction in relation to the housing, wherein the second rotational direction is opposite to the first rotational direction. A counting device detects a residual trimmer line length of the trimmer line remaining on the trimmer line spool. The counting device is connected to the trimmer line spool such that the counting device counts up when the trimmer line spool rotates in relation to the housing in the first rotational direction and counts down when the trimmer line spool rotates in relation to the housing in the second rotational direction.

### BACKGROUND OF THE INVENTION

The invention relates to a trimmer head for mounting on a drive shaft of a trimmer.

A trimmer serves for mowing grass, shrub or the like. For this purpose, a trimmer head with a tool is driven in rotation about an axis of rotation of the trimmer head so that the grass is cut off upon contact with the tool. As a tool, trimmer lines are used which are subject to a certain wear in operation of the trimmer head. During operation of a trimmer head, the trimmer line must be readjusted several times so that a sufficient length of trimmer line is available and the cutting function of the trimmer head is not impaired. When the trimmer line is completely unwound from the trimmer line spool, a new trimmer line must be inserted into the trimmer head.

It is advantageous when the operator is enabled to anticipate an upcoming change of the trimmer line. This enables the operator to keep at hand a replacement trimmer line and to change at the site of use the trimmer line, as needed. The operator, in preparation before even beginning work, can change the trimmer line so that an interruption of the work on site is not necessary.

WO 2018/153424 A1 discloses a trimmer head with a trimmer line wherein the trimmer line comprises sections of different color. Based on the differently colored sections of the trimmer line, the user can recognize how much trimmer line is already used up and when to expect a necessary exchange of the trimmer line. A disadvantage of such systems is that the recognition of the residual trimmer line length is possible only as a function of the trimmer line type.

It is an object of the invention to develop a trimmer head with an alternative residual trimmer line indicator.

### SUMMARY OF THE INVENTION

In accordance with the invention, this is achieved by a trimmer head for mounting on a drive shaft of a trimmer, wherein the trimmer head comprises a housing and a trimmer line spool for winding and unwinding a trimmer line, wherein the trimmer line spool is rotatably supported in relation to the housing about an axis of rotation, wherein the trimmer line spool comprises, in relation to the housing, a first rotational direction and a second rotational direction opposite to the first rotational direction, wherein the trimmer head comprises a counting device for detecting the residual trimmer line length, wherein the counting device is operatively connected to the trimmer line spool such that the counting device is counting up upon rotation of the trimmer line spool in the first rotational direction in relation to the housing and is counting down upon rotation of the trimmer line spool in the second rotational direction in relation to the housing.

The trimmer head according to the invention comprises a trimmer line spool for winding and unwinding a trimmer line. The trimmer line spool comprises, in relation to the housing, a first rotational direction and a second rotational direction opposite to the first rotational direction. The trimmer head comprises a counting device for detecting the residual trimmer line length. The counting device is operatively connected to the trimmer line spool in such a way that the counting device counts up upon rotation of the trimmer line spool in the first rotational direction in relation to the housing and counts down upon rotation of the trimmer line spool in the second rotational direction in relation to the housing.

When the trimmer line is wound onto the trimmer line spool, the counting device counts up. When the trimmer line is unwound from the trimmer line spool, the trimmer line spool rotates in the second rotational direction in relation to the housing and the counting device counts down. In this context, the counter value is indicated by the counting device at least indirectly. In this way, the operator is advised by the counting device how much residual trimmer line length is still remaining on the trimmer line spool. The determination of the residual trimmer line length is realized independent of the configuration of the trimmer line.

Preferably, the counting device comprises a counter wherein the counter determines the relative rotation between trimmer line spool and housing. Advantageously, the counter is a mechanical, an electronic, or an electromechanical counter. By means of the counter, the relative rotations between trimmer line spool and housing can be measured by which the trimmer line is wound onto the trimmer line spool.

It is advantageously provided that at the trimmer line spool of the trimmer head at least one actuating element is provided wherein the counter is actuated at least once by means of the at least one actuating element for each relative rotation between the trimmer line spool and the housing. In this way, the counter counts the numerical value up or down by 1 for each revolution. Advantageously, a plurality of actuating elements can be provided also wherein the counter for each revolution determines a counter value which corresponds to the number of actuating elements.

The actuating element is preferably a tooth element which is arranged at the trimmer line spool. It is advantageously provided that the actuating element is a ring gear which is arranged at the trimmer line spool, wherein the counter is continuously actuatable by the ring gear at the trimmer line spool. By use of a ring gear, an extremely precise determination of the relative rotation between trimmer line spool and housing and thus of the trimmer line length that is wound onto the trimmer line spool is enabled.

It is advantageously provided that the actuating element is a pulse generator arranged at the trimmer line spool, wherein the counter is embodied as a pulse counter for recording the pulses that are emitted by the at least one pulse generator. The pulse counter is preferably an optical sensor, in particular an inductive or a capacitive proximity sensor. In this configuration, the counting process can be realized without mechanical contact between the actuating element and the counter. The counter is preferably embodied as a rotary encoder. In this way, a precise indication of the rotation angle can be provided.

The counting device comprises preferably an output element coupled with the counter, wherein the counter value which is determined by the counter is indicated at least indirectly by the output element. The output element is preferably arranged on the housing so as to be visible by the operator of the trimmer head. In this way, the operator can detect how much residual trimmer line length is still wound on the trimmer line spool even in the installed state of the trimmer line spool.

The counting device is preferably configured such that the counting device has a zero position when the trimmer line has been unwound from the trimmer line spool. When winding trimmer line onto the trimmer line spool, the counter counts up so that the operator based on the output element can recognize the trimmer line length that has been wound onto the spool. Upon unwinding the trimmer line from the trimmer line spool, the trimmer line spool is rotated in relation to the housing in the second rotational direction and the counter counts down until the trimmer line has been completely unwound and the counting device has again reached the zero position.

It is preferably provided that the trimmer line spool comprises at least one continuous trimmer line channel through which the trimmer line can be pushed and then wound onto the spool. For winding the trimmer line, the trimmer line has to be pushed through the trimmer line channel and subsequently the trimmer line spool is to be rotated in the first direction relative to the housing. Preferably, the trimmer line spool comprises at least two holding devices for fastening two trimmer lines. In this way, one trimmer line can be fixed at each holding device and the trimmer lines can be subsequently wound onto the trimmer line spool.

### BRIEF DESCRIPTION OF THE DRAWING

Further features of the invention result from the description and the drawing. Embodiments are illustrated which will be described in detail in the following.

FIG. 1 is a schematic illustration of a trimmer held by an operator.

FIG. 2 is a side view of an embodiment of a trimmer head with residual trimmer line indicator.

FIG. 3 is a section illustration of the trimmer head according to FIG. 2.

FIG. 4 is a schematic illustration of an embodiment of a trimmer head with mechanical counter.

FIG. 5 is a schematic illustration of an embodiment of a trimmer head with electromechanical counter.

### DESCRIPTION OF PREFERRED EMBODIMENTS

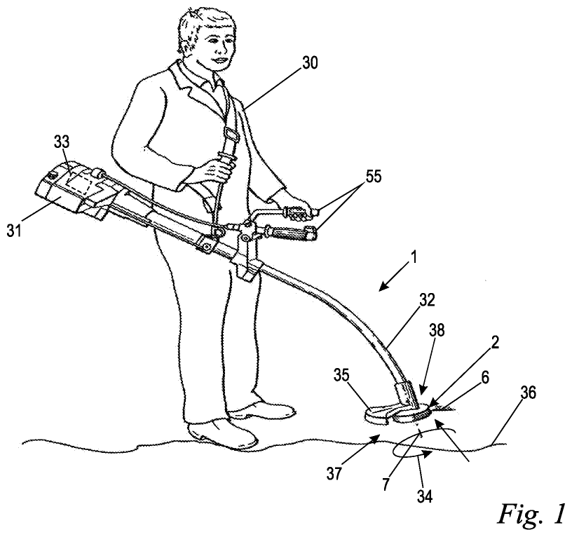

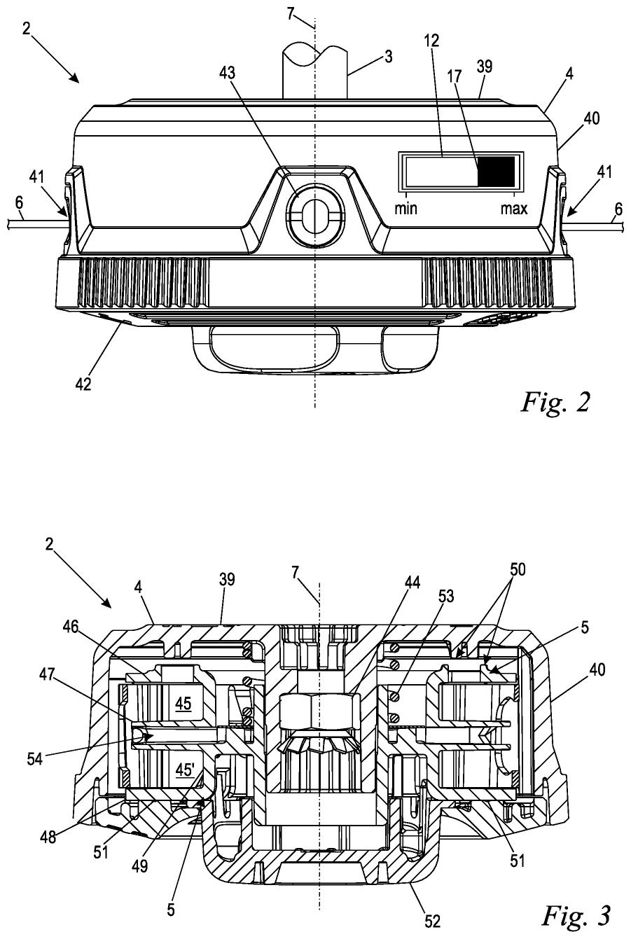

FIG. 1 shows a trimmer 1 in a schematic illustration. The trimmer 1 is held by an operator 30. The trimmer 1 comprises a rearward end with a rearward housing 31 and a front end from which a drive shaft 3 (FIG. 2) projects. A shaft 32 connects the rearward end and the front end. Handles 55 for guiding the trimmer 1 are arranged at the shaft 32. A trimmer head 2 adjoins the front end of the trimmer 1. The trimmer head 2 is fastened to the drive shaft 3 and is driven in rotation about an axis of rotation 7 by a drive motor 33, only schematically indicated, in a rotational direction 34 for work. The drive motor 33 is arranged in the rearward housing 31 wherein a drive shaft is extending in the shaft 32. It can be provided that this drive shaft is connected inside the shaft immediately to the drive shaft 3 for the trimmer head 2 so that no gearbox is positioned inbetween. In an alternative embodiment, not illustrated, the drive motor 33, which is in particular an electric motor, can also be arranged at a front housing, not illustrated, that is arranged at the front end. Advantageously, in the front housing there is also a gear box of the trimmer head 2. The trimmer head 2 is provided with a protective shield 35 at the side which is facing the operator 30 in operation. The trimmer head 2 comprises at least one tool, which is a trimmer line 6 in the embodiment, for cutting things such as grass, shrubs or the like. A bottom side 37 is formed at the trimmer head 2 and faces the ground 36 in operation; it is arranged at the side of the trimmer head 2 facing away from the shaft 32. At the side of the trimmer head 2 which is facing the shaft 32, the top side 38 of the trimmer head 2 is formed. Protective gear that has to be worn mandatorily by the operator 30 for operating the trimmer 1 is not illustrated in the simplified illustration of FIG. 1.

In FIG. 2, the trimmer head 2 is illustrated in a side view. The trimmer head 2 comprises an axis of rotation 7 about which the trimmer head 2 is rotated in operation of the trimmer 1. For this purpose, the trimmer head 2 is driven by the only schematically illustrated drive shaft 3. In addition, the trimmer head 2 comprises a housing 4 and a trimmer line spool 5 (FIGS. 3 to 5) arranged in the housing 4. The housing 4 of the trimmer head 2 is cup-shaped and comprises in the embodiment a cover member 39 and a circumferential wall 40. The cover member 39 extends, beginning at the axis of rotation 7, in radial direction of the axis of rotation 7. The cover member 39 in the embodiment is oriented approximately perpendicularly to the axis of rotation 7 of the trimmer head 2. The circumferential wall 40 adjoins the cover member 39 and extends in the direction of the axis of rotation 7. At the circumferential wall 40 of the housing 4, two oppositely positioned trimmer line openings 41 are provided through which the trimmer line 6 projects out of the housing 4. The trimmer head 2 comprises in the embodiment a housing cover 42 that is fastened by two snap-on connections 43 at the housing 4. By means of the housing cover 42, the components arranged in the housing 4 are secured in the housing and protected from becoming soiled.

As illustrated in FIG. 3, the trimmer line spool 5 is rotatably supported in relation to the housing 4 about the axis of rotation 7. The trimmer line spool 5 comprises at least one spool chamber 45, 45′ for winding a trimmer line 6 therein. In the preferred embodiment according to FIG. 3, the trimmer line spool 5 comprises two spool chambers 45, 45′ arranged one after the other in the direction of rotation 7 into which a trimmer line 6 can be wound, respectively. The trimmer line spool 5 comprises a first spool wall 46, a second spool wall 48, and an intermediate wall 47 arranged between the first spool wall 46 and the second spool wall 48. The trimmer line spool 5 comprises moreover a longitudinal wall 49 that connects the first spool wall 46, the intermediate wall 47, and the second spool wall 48 with each other. One of the two spool chambers 45 is delimited in the direction of the axis of rotation 7 by the first spool wall 46 and the intermediate wall 47. In radial direction in relation to the axis of rotation 7, the spool chamber 45 is delimited by the longitudinal wall 49. The other one of the two spool chambers 45 is delimited in the direction of the axis of rotation 7 by the intermediate wall 47 and the second spool wall 48. In radial direction relative to the axis of rotation 7, the other spool chamber 45′ is delimited by the longitudinal wall 49.

For winding the trimmer line 6 on the spool, the trimmer line spool 5 has a continuous trimmer line channel 54 through which the trimmer line 6 can be pushed and then wound onto the spool. Such a continuous trimmer line channel 54 enables the operator to wind the trimmer line 6 onto the spool in the mounted state of the trimmer head 2. In such a state, the trimmer line spool 5 is held in the housing 4 of the trimmer head 2. The operator pushes the trimmer line 6 into the trimmer line channel 54 and aligns it in such a way that trimmer line ends of approximately the same length project from the trimmer line channel 54 at the respective ends of the trimmer line channel 54. Subsequently, the trimmer line spool 5 is rotated in a first rotational direction in relation to the housing 4. Each free end of the trimmer line 6 then is wound into one of the spool chambers 45, 45, respectively. In the embodiment, such a trimmer line channel 54 is provided in the intermediate wall 47 of the trimmer line spool 5.

Instead of or in addition to the trimmer line channel 54, the spool chambers 45, 45′ can be provided with trimmer line holders at which a respective trimmer line 6 can be held. The trimmer line 6 is fixed at the trimmer line holder and, by a rotation of the trimmer line spool 5 relative to the housing 4, is subsequently wound onto the trimmer line spool 5 in one of the spool chambers 45, 45′. In this way, several trimmer lines 6 can be wound onto the trimmer line spool 5.

When in operation of the trimmer head 2 the trimmer line 6 is worn at its ends, it must be unwound from the trimmer line spool 5 for lengthening the ends extending from the housing 4. For this purpose, the trimmer head 2 comprises an indexing device 50. As illustrated in FIG. 3, the indexing device 50 is comprised of a plurality of locking contours 51. The locking contours 51 have the effect that in an operational position of the trimmer head 2 the trimmer line spool 5 is fixedly connected to the housing 4 for common rotation in the working rotational direction 34. For unwinding the trimmer line 6 from the trimmer line spool 5, the fixed connection of the locking contours 51 between trimmer line spool 5 and the housing 4 must be canceled and subsequently the trimmer line spool 5 rotated in the second rotational direction 9 opposite to the working rotational direction 34 about the axis of rotation 7 relative to the housing 4. The second rotational direction 9 is opposite to the first rotational direction 8. In the embodiment, the connection between the locking contours 51 can be canceled by an actuating device 52 projecting through the housing cover 42. The actuating device 52 is to be pushed in the direction of the axis of rotation 7 toward the cover member 39 of the housing 4. This can be realized by hitting the trimmer head 2 against the ground 36. In doing so, the trimmer line spool 5 is lifted in the direction of the axis of rotation 7 so that the locking contours 51 release. The housing 4 rotates further; by release of the rotational connection, the trimmer line spool 5 rotates relative to the housing 4 and the trimmer line 6 is unwound. By a spring element 53, the trimmer line spool 5 is pushed back into the locked position after a predetermined angle rotation so that the rotational connection between the trimmer line spool 5 and housing 4 is reinstated.

In an alternative embodiment, the indexing device 50 can also be designed such that, for canceling the rotational connection between the trimmer line spool 5 and the housing 4, the trimmer line spool 5 must be pulled in the direction away from the cover member 39 of the housing 4 in the direction of the axis of rotation 7. Subsequently, the trimmer line spool 5 is to be rotated by hand relative to the housing 4 in order to unwind the trimmer line 6 from the trimmer line spool 5.

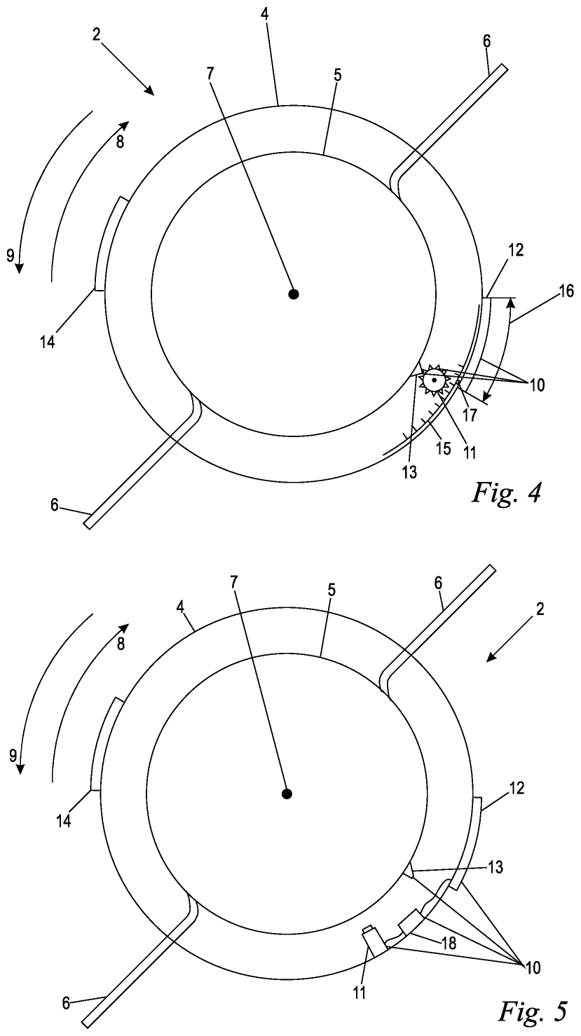

As illustrated in FIGS. 4 and 5, the trimmer head 2 comprises a counting device 10. The counting device 10 serves to detect the relative rotation of housing 4 and trimmer line spool 5 and, by means of an output element 12 coupled therewith, to indicate to the operator how much residual trimmer line length is still wound on the trimmer line spool 5. The output element 12 can be coupled to the counter mechanically, electromechanically or electronically. Removal of the trimmer line spool 5 from the housing 4 or demounting the trimmer head 2 is not required for this. In this way, the operator can be informed in a simple way of the point in time when a new trimmer line 6 is presumably to be wound onto the trimmer line spool 5. Thus, it is possible for the operator to take care of procuring a new trimmer line in due time.

For winding the trimmer line 6 onto the trimmer line spool 5, the trimmer line spool 5 is to be rotated in the first rotational direction 8 about the axis of rotation 7 relative to the housing 4. For unwinding the trimmer line 6 from the trimmer line spool 5, the trimmer line spool 5 is to be rotated in the second rotational direction 9 opposite to the first rotational direction 8.

As illustrated in FIGS. 4 and 5, the counting device 10 comprises a counter 11 and an output element 12 coupled with the counter 11. The counter 11 is preferably arranged at the housing 4. The counter 11 is operatively connected to the trimmer line spool 5 such that the counter 11 counts up upon relative rotation between trimmer line spool 5 and housing 4 in the first rotational direction 8 and counts down in the second rotational direction 9. The counter 11 is designed such that the counter 11 is in a zero position when there is no trimmer line 6 wound on the trimmer line spool 5. For winding the trimmer line 6 onto the trimmer line spool 5, the operator rotates the trimmer line spool 5 in the mounted state of the trimmer head 2 relative to the housing 4 in the first rotational direction 8. In doing so, the counter 11 counts at least each individual relative revolution of the trimmer line spool 5 relative to the housing 4. In an alternative embodiment of the trimmer head 2, the trimmer head 2 can also be designed such that the relative movement between trimmer line spool 5 and housing 4 for winding the trimmer line 6 onto the spool 5 is effected by a motor, in particular by the drive motor. When the trimmer line 6 is unwound from the trimmer line spool 5, the trimmer line spool 5 is rotated in the second rotational direction 9 relative to the housing 4, wherein in this direction the counter 11 counts down. The counter value which is generated by the counter 11 is transmitted to the output element 12 which is embodied in particular as an indicator element wherein the output element 12 communicates the counter value to the operator. The counter value is transmitted by the output element 12 acoustically and/or visually.

Upon winding the trimmer line 6 onto the spool, the counting device 10 provides for initializing the length of the trimmer line 6. Accordingly, the length of a trimmer line 6 is determined. Therefore, the use of a trimmer line of a predetermined length is not required for a correct determination of the residual trimmer line length. It is possible for the operator to use trimmer lines of various lengths.

The counter 11 can be a mechanical, in particular an electromechanical, preferably electronic counter 11. In the embodiment of the counter 11 as a mechanical counter, preferably an actuating element 13, here embodied as a tooth element, is provided at the trimmer line spool 5 and actuates the counter 11 with each revolution. A compensation weight 14 for an imbalance-free weight distribution of the trimmer head 2 is provided for the counting device 10. Such a compensation weight 14 can be designed as simple weighting elements. Also, a second counting device with output element is conceivable that is designed to be symmetrical to the first counting device 10 in relation to the axis of rotation 7.

In addition, in an alternative embodiment according to the invention of the trimmer head 2, it can be expedient to distribute a plurality of actuating elements 13 at the trimmer line spool 5 in the circumferential direction of the axis of rotation 7 in order to actuate the counter 11 several times per revolution. With increasing number of actuating elements 13, a more exact determination of the residual trimmer line length is possible. Alternatively, a ring gear can be provided instead of individual tooth elements at the trimmer line spool 5, wherein the ring gear is operatively connected to the counter 11. Preferably, a gear unit is provided between the counter 11 and the ring gear so that a continuous determination of the residual trimmer line length is possible. The counter 11 is illustrated schematically in FIG. 4 as a gear wheel which is supported in the housing 4. Of course, as a counter 11 typical counters such as roller counters, quantity counters can be used.

In an alternative embodiment of the trimmer head 2, the counter of the counting device 10 can be embodied as an electromechanical or electronic counter. As shown in FIG. 5, the actuating element 13 that is provided at the trimmer line spool 5 can also be configured as a pulse generator. The counter 11 is designed as a pulse counter. The pulse counter can be an inductive proximity sensor, a capacitive proximity sensor but also an optical sensor. For a more precise resolution and determination of the residual trimmer line length, a rotary speed encoder can be provided also as a counter 11. For determining whether the trimmer line spool 5 is rotating in a first rotational direction 8 or a second rotational direction 9, the pulse generator is preferably configured such that the detected pulse is designed nonuniform. In this way, the rotational direction of the trimmer line spool 5 can be detected based on the pulse signal.

As shown in FIGS. 4 and 5, the output element 12 is arranged at the housing 4. In the embodiment, the output element 12 is arranged at the circumferential wall 40 of the housing 4. However, it can also be expedient to arrange the output element 12 on the cover member 39 of the housing 4. The output element 12 is arranged at the housing 4 such that it is possible for the operator to recognize the output element 12 in the mounted state of the trimmer head 2 so that the operator can derive the residual trimmer line length of the trimmer line 6 based on the information provided by the output element 12.

As illustrated in FIGS. 4 and 5, the output element 12 is coupled with the counter 11 for indicating the residual trimmer line length. In case of a mechanical counting device 10, the output element 12 can be, for example, a slider element 15. The slider element 15 is displaced by the counter 11. A marking 17 is provided on the slider element 15. By means of an indicator region 16 of the output element 12, the operator can view the slider element 15. Based on the position of the marking 17 provided on the slider element 15, the operator can detect how much residual trimmer line length of the trimmer line 6 is still wound on the trimmer line spool 5. The indicator region 16 can be provided, for example, by an opening provided in the housing 4 or by a transparent housing section. The marking 17 of the slider element 15 can be formed also by a combination of various color gradations of the slider element 15, for example, green, yellow, red. Also, other markings 17 are conceivable that can indicate the residual trimmer line length to the operator. Instead of a marking 17, also numerals can be provided that represent the number of actuations or the remaining residual trimmer line length as a unit of measure. In this embodiment variant, the output element 12 is mechanically coupled with the counter 11. The slider element 15, its marking 17, and the indicator region 16 are components of the output element 12.

As illustrated in FIG. 5, in case of an electromechanical counter 11 the counted pulses are processed by a control unit 18 and transmitted to the output element 12. The output element 12 in this embodiment is preferably configured as a digital display. The pulses which are detected by the counter 11 are output as a numerical value.

Alternatively, a computational conversion, based on the diameter of the trimmer line spool 5, to the actual residual trimmer line length can be realized so that the output element 12 indicates the residual trimmer line length as a unit of length.

In an alternative embodiment, it can be expedient to design the trimmer head 2 such that the counter 11 is fixedly connected to the trimmer line spool 5 and the actuating element 13 is fixedly connected to the housing 4.

The specification incorporates by reference the entire disclosure of European priority document 19 218 095.8 having a filing date of Dec. 19, 2019.

While specific embodiments of the invention have been shown and described in detail to illustrate the inventive principles, it will be understood that the invention may be embodied otherwise without departing from such principles.

What is claimed is:

1. A trimmer head for mounting on a drive shaft of a trimmer, the trimmer head comprising:
a housing;
a trimmer line spool configured to wind and unwind a trimmer line, wherein the trimmer line spool is supported in the housing so as to be rotatable in relation to the housing about an axis of rotation, wherein the trimmer line spool comprises a first rotational direction in relation to the housing and a second rotational direction in relation to the housing, wherein the second rotational direction is opposite to the first rotational direction;
a counting device configured to detect a residual trimmer line length of the trimmer line remaining on the trimmer line spool;
wherein the counting device is operatively connected to the trimmer line spool such that the counting device counts up when the trimmer line spool rotates in relation to the housing in the first rotational direction and counts down when the trimmer line spool rotates in relation to the housing in the second rotational direction.

2. The trimmer head according to claim 1, wherein the counting device comprises a counter, wherein the counter determines a relative rotation between the trimmer line spool and the housing.

3. The trimmer head according to claim 2, wherein the counter is selected from the group consisting of a mechanical counter, an electronic counter, and an electromechanical counter.

4. The trimmer head according to claim 2, further comprising at least one actuating element arranged at the trimmer line spool, wherein the counter is actuated by the at least one actuating element at least once for each relative rotation between the trimmer line spool and the housing.

5. The trimmer head according to claim 4, wherein the at least one actuating element is a tooth element arranged at the trimmer line spool.

6. The trimmer head according to claim 4, wherein the at least one actuating element is a ring gear arranged at the trimmer line spool, wherein the counter is configured to be actuated continuously by the ring gear at the trimmer line spool.

7. The trimmer head according to claim 4, wherein the at least one actuating element is a pulse generator arranged at the trimmer line spool and configured to emit at least one pulse, wherein the counter is configured as a pulse counter configured to detect the at least one pulse emitted by the pulse generator.

8. The trimmer head according to claim 7, wherein the pulse counter is selected from the group consisting of an optical sensor, an inductive proximity sensor, and a capacitive proximity sensor.

9. The trimmer head according to claim 7, wherein the counter is a rotational angle encoder.

10. The trimmer head according to claim 2, wherein the counting device comprises an output element coupled to the counter, wherein a counter value determined by the counter is output by the output element at least indirectly.

11. The trimmer head according to claim 10, wherein the output element is arranged at the housing so as to be visible by an operator of the trimmer head.

12. The trimmer head according to claim 1, wherein the counting device is embodied such that the counting device is in a zero position when the trimmer line has been unwound from the trimmer line spool.

13. The trimmer head according to claim 1, wherein the trimmer line spool comprises at least one continuous trimmer line channel, wherein the trimmer line is pushed through the continuous trimmer line channel and then wound onto the trimmer line spool.

14. The trimmer head according to claim 1, wherein the trimmer line spool comprises at least two holding devices configured to fasten at least two trimmer lines to the trimmer line spool.
